(19) United States
(12) Patent Application Publication
(10) Pub. No.: US 2007/0283269 A1
(43) Pub. Date: Dec. 6, 2007

(54) Method and system for onboard camera video editing

(76) Inventors: Pere Obrador, Palo Alto, CA (US); Tong Zhang, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/443,250

(22) Filed: May 31, 2006

(51) Int. Cl. G06T 15/70

(52) U.S. Cl. 715/723; 345/473

(57) ABSTRACT

A method and system are disclosed for onboard camera video editing. A video clip is segmented into at least one video segment having frames and the video quality of at least one frame is assessed to derive a quality score per frame and an average quality score for the video segment. To optimize quality of the video captured and to increase free memory space, at least one video segment is removed from the digital memory based on the quality score per frame and the average quality score.

### BACKGROUND

A scene can be captured by a series of video clips or shots. When a user takes a shot, what results is a series of continuous frames captured, for example, in an onboard video memory. A captured video can then be downloaded as one or more video files to a computer. Once downloaded to a computer, a video file can be processed and edited using a video editing software.

Digital cameras are used to capture short scenes or shots. With some digital cameras, simple onboard video editing is possible, such as deletion or merging of video clips. However, a user may run out of memory. For example, especially during a long trip or a long event such as parties, weddings, vacation, etc.

### SUMMARY OF THE INVENTION

An onboard camera video editing system having a digital memory to capture video is disclosed. The system includes a video segmentation unit which segments a video clip into a video segment having frames and a video quality assessment unit which assesses video quality of at least one frame and derives a quality score per frame and an average quality score for the video segment. A video quality optimizer removes at least one video segment with low quality from the digital memory to provide increased memory space for future video capture.

An onboard camera video editing method is also disclosed to edit captured video for a digital memory. The method includes segmenting a video clip into at least one video segment having frames and assessing the video quality of at least one frame to derive a quality score per frame and an average quality score for the video segment. At least one video segment is removed from the digital memory based on the quality score per frame and the average quality score to optimize quality of the video captured in the digital memory and to increase free memory space.

### BRIEF DESCRIPTION OF THE DRAWING FIGURES

The figures illustrate exemplary concepts and embodiments of methods and systems for onboard camera video editing as disclosed, wherein:

FIG. 1 shows an exemplary flowchart of an onboard camera video editing process onboard a digital camera;

FIG. 2 shows an exemplary curve of user's pressure in relation to a used memory space;

FIG. 3 shows an exemplary flowchart for segmenting a video clip into one or more micro-shots (μ-shots);

FIG. 4 shows an exemplary flowchart for quality assessment;

FIG. 5 shows an exemplary curve of quality scores of frame; and

FIG. 6 shows an exemplary curve relating to rate-quality optimization of video.

### DETAILED DESCRIPTION

A method and system for onboard camera video editing are disclosed, wherein video clips can be edited onboard a digital video equipment, such as a camera. However, the equipment can be any video editing device having or interfacing a digital memory, such as a random access memory, other solid-state memory, blue ray disc, various forms of HD DVD, and so forth.

The method and system disclosed can help manage memory usage while a user is using the equipment (camera) and alleviate the concerns over memory management for a video or picture taking event. In addition, the method and system for onboard camera video editing can help to improve the overall quality of the whole video recording by detecting and removing low quality segments of video. The method and system can also serve as an advisor to the user on memory management or video quality.

Various aspects will now be described as steps or elements that can be performed by elements of a computer or processor. For example, it will be recognized that the various actions can be performed by specialized circuits or circuitry (e.g., discrete and/or integrated logic gates interconnected to perform a specialized function), by program instructions being executed by one or more processors, or by a combination of both.

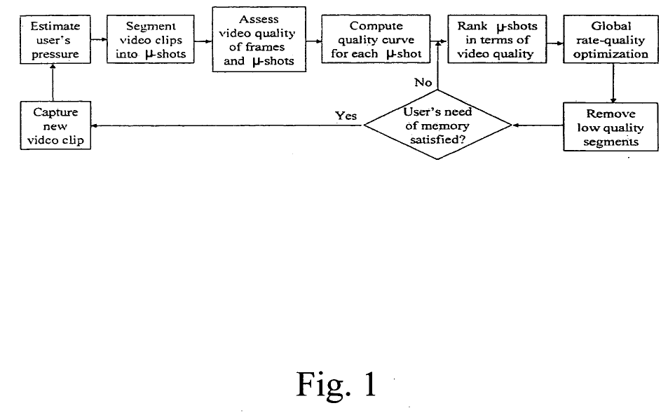

An exemplary video editing process, as shown in FIG. 1, can estimate user's pressure and can provide video segmentation, video quality measurement, optimization of overall video quality and user interaction. In order not to affect the performance of the camera during video capture of a new video clip, some or all of the processing could be done off-line, e.g., when the camera is on, but not in the capture mode.

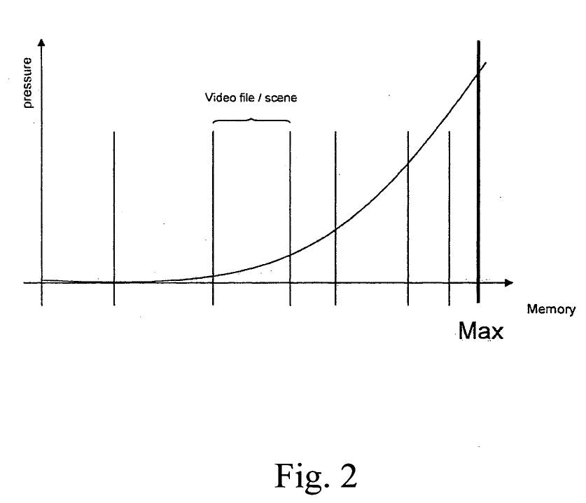

When using a digital camera, the user may become concerned about when the memory space might be running out. An estimation unit can be provided to estimate the user's pressure over his concerns about when the memory space might be running out. The user's pressure can be estimated as a function of a ratio between the size of available memory and the average size of captured video clips, as illustrated in FIG. 2. The estimation of normalized pressure can be expressed as:

User pressure=f (Remaining Buffer Space/Average (Clip Size)). (1)

In practice, the pressure can depend on the amount of memory space left and the user's expectation of upcoming events, e.g., how much more video will be taken during the rest of the party, of the trip, of the day, etc. To reduce the user's pressure, some data can be removed from the memory card. The method and system for onboard camera video editing can solve the problem of choosing the right data to remove to alleviate the modeled user pressure.

A video segmentation unit segments a video clip into video segments having frames. Each video clip can be segmented into one or more segments (called micro-shot, or μ-shot) by tracking camera motion, as well as some other available clues, such as light changes, audio events, and user indexing, e.g., audio or text annotation. A micro-shot can be a semantic unit of video showing one scene or one object. This segmentation partitions video clips, which otherwise tend to be long and unedited, and segments different scenes and/or objects. As segmented, different segments within one clip can have different quality levels.

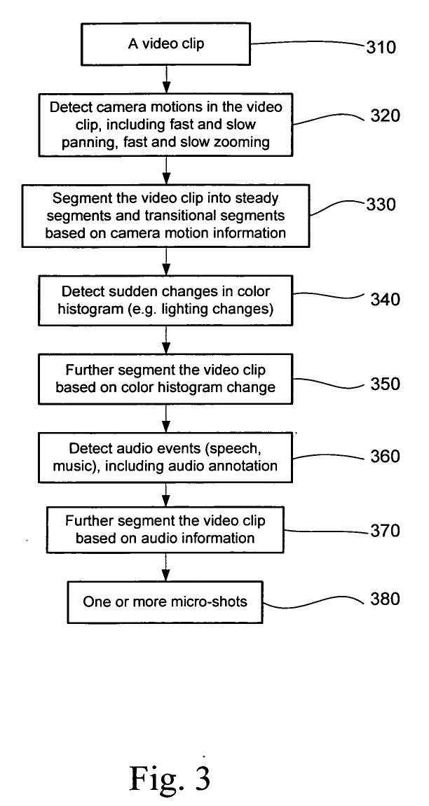

An exemplary flowchart for segmenting a video clip into one or more micro-shots (μ-shots) is shown in FIG. 3. In an onboard camera video editing system and method, a video clip is captured (block 310) for editing and storage in digital memory. In block 320, camera motion is detected in the video clip, including fast and slow panning, and fast and slow zooming. In block 330, the video clip is segmented into steady segments and transitional segments based on camera motion information. In block 340, sudden changes in color histogram, e.g., lighting changes, can be detected. In block 350, the video clip is further segmented based on color histogram changes. In block 360, an audio event, e.g., speech, music and/or audio annotation, is detected. In block 370, the video clip is further segmented based on the detected audio information. In block 380, one or more micro-shots are derived.

A video clip containing fast panning or zooming motions, for example, might be separated into relatively stable segments, e.g., when camera is not in motion, and transitional segments, e.g., when camera is in fast motion, by analyzing camera motions. The transitional segments are considered lacking semantic meaning, thus having low quality, and can be candidates to be removed.

A video quality assessment unit assesses video quality of at least one frame, e.g., every frame or at an interval of frames, and derives a quality score per frame and an average quality score for the video segment. Video quality of each μ-shot shot and the frames within an μ-shot can be assessed by analyzing at least one video feature, including: Camera motion, histogram analysis to identify bad exposure, out-of-focus detection, brightness, noisy frame detection, shaking and rotation, periodic camera motion or large amplitude of rotation detection, audio highlights detection, face detection, and detection of other metadata at different levels. For example, an exemplary onboard camera video editing system can implement a video quality assessment process based on at least one of presence of facial features and a color histogram.

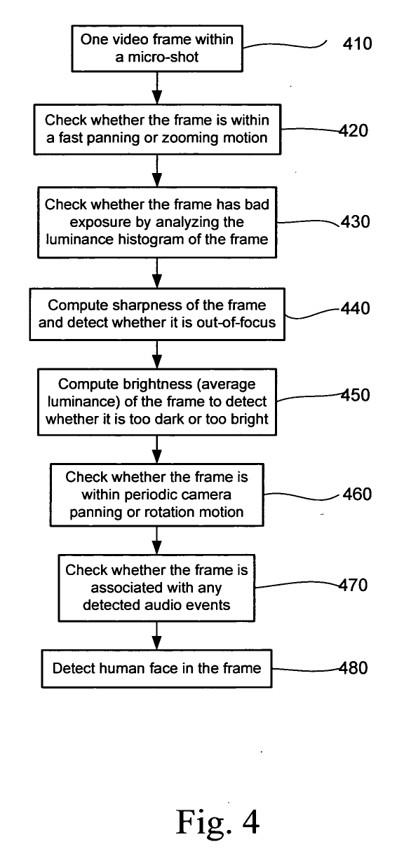

An exemplary flowchart for quality assessment is shown in FIG. 4. As shown in block 410, quality can be assessed for a given frame within a micro-shot. In block 420, the quality assessment function checks to determine whether the frame is within a fast panning or zooming motion. In block 430, the quality assessment function checks to determine whether the frame has bad exposure by analyzing the luminance histogram of the frame. In block 440, sharpness of the frame is computed, and an out-of-focus frame is detected. In block 450, brightness of the frame, e.g., average luminance, is computed to detect whether it is too dark or too bright. In block 460, the quality assessment function checks to determine whether the frame is within periodic camera panning or rotation motion. In block 470, the frame is checked to see if it is associated with any detected audio event. In block 480, human facial features are detected to ascertain the presence of a human face.

Fast camera motion can include panning, tilting and zooming. Fast camera motions often appear in unedited video clips. They are transitional and lack semantic meaning. In addition, frames within fast camera motions tend to be blurry. Thus, micro-shots of fast camera motion can be assessed as low quality.

Histogram analysis can be used to identify bad exposure. Frames taken under bad lighting conditions can be detected by analyzing the histogram. They can be assessed as low quality.

Frames which are out-of-focus can be detected by image analysis methods, such as checking the sharpness of frames. They can be assessed as low quality.

Very dark μ-shots or segments can be detected by checking brightness of the frames. Such an μ-shot or segment can be assessed as low quality.

Frames within micro-shots or segments that are taken under low light conditions tend to be noisy. Such a micro-shot or segment can be assessed as low quality.

In amateur video clips, shaking and unintended camera rotations often appear which result in jerky motions and blurry frames. Such segments can be detected by analyzing camera motions, frame sharpness, etc. They can be assessed as low quality.

There may be segments containing periodic camera motion or large amplitude of rotation. Appearance of such segments may be unintentional, for example, when the user forgets to turn off the camera. That is, the user may have thought the camera was off, when it was on. These segments can be assessed as junk segments, and are to be removed first.

Detecting events in the audio track such as singing (especially multiple people), laughter, screaming, etc., may help to find highlights in the video. Such segments can be assessed as high quality.

Face detection can be applied to every frame, or once every N frames, depending on available computing power. Segments with one or more faces that are detected can be assessed as high quality.

Other metadata available from the camera or video bit-streams may help to assess video quality as well. They can be at different levels, such as timestamp, GPS-derived information and low-level features. If a camera can record user interaction while shooting, that can also be detected as metadata. For example, in one exemplary embodiment, a certain button can be made available to a user for user intervention, wherein a particular micro-shot (μ-shot) can be assigned a quality value, e.g., a top quality value, based on the user pressing the button, rather than being based on an analysis.

Each of the above features can be quantized and normalized to a value having a range, e.g., between 0 and 1. Quality can be indicated with the value of 1 to indicate the highest quality and the value of 0 to indicate the lowest quality. Next, a weighted average of these values can be computed to generate a quality score for each frame.

A set of heuristic rules can be defined for quantizing, normalizing and weighting qualities of different features. For example, for some features such as the sharpness and the brightness, two empirical thresholds can be defined. Those frames with a value above the higher threshold can be assigned a quality value of 1; those frames with a value under the lower threshold can be assigned a quality value of 0; and those frames with a value between the two thresholds can get a quality value between 0 and 1. Also, some features can have a heavier weight than others. For instance, junk segments taken when the user forgot to turn off the camera are given higher priority to be removed than low quality segments of other features.

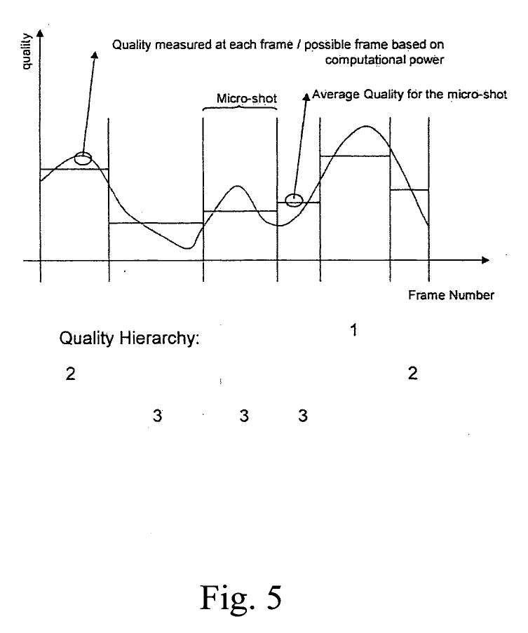

Once the quality score of frames within an μ-shot are estimated, a quality curve can be generated as exemplified in FIG. 5. Based on quality scores of frames within an μ-shot, the overall quality of the μ-shot can be assessed. For this purpose, both the average frame quality score of the μ-shot and the length of the μ-shot are considered. For example, very short and bad μ-shots are considered the worst μ-shots that are to be erased first. While relatively long μ-shots can be made shorter by removing low quality frames, or groups of frames, within.

A simple measure of μ-shot quality can be expressed as:

Qᵢ=(Σ quality)/length, (2)

wherein “Σ quality” is the sum of quality scores of frames in the μ-shot, and “length” is the length of the μ-shot (in time or number of frames). However, for short μ-shot lengths, e.g., less than 10 seconds, a simple measure of the μ-shot quality can be expressed as:

Qᵢ ∝ Σ quality, (3)

### In either case, all existing μ-shots on the memory card can be ranked in terms of video quality.

To optimize the overall quality of all video recordings on a memory card, a global rate-quality optimization of video can be performed, e.g., the allocation of memory space to μ-shots to achieve a high overall quality. For example, a video memory usage may be considered optimized when a certain quality level is achieved for all the footage recorded in the memory card. In that sense, it may be suboptimal to have kept a low quality shot in lieu of a high quality shot that could have been saved in the memory space.

Optimizing the overall quality of all video recordings maintains a sense of consistency in visual quality across all the footage stored in a memory card. In the absence of such an optimization scheme, the stored shots would nevertheless have various levels of quality, e.g., quality values above zero. However, memory usage is qualitatively improved when the memory is selectively filled based upon good quality footage. An exemplary overall quality measure of all video stored in memory can be expressed as:

i Qₒᵥₑᵣₐₗₗ=Σ \hat{Q}ᵢ/N, (4)

wherein, N is the number of μ-shots in the memory, the modified μ-shot quality \hat{Q}ᵢ is defined as:

\hat{Q}=fᵢ·fᵢ′·fᵢ″·Qᵢ, (5a)

wherein,

fᵢ=a function of μ-shot recompression, (5b)

fᵢ=a function of μ-shot down sampling, and (5c)

f”=a function of frame deletions. (5d)

In one exemplary embodiment, certain segments of video of very low quality will be directly erased. If, however, despite the low-quality erasures, the segments remaining in the memory possess higher quality levels than a given threshold quality value, then the system may optionally attempt to further free up memory by (1) trying to recompress a given segment, e.g., recompress to a higher compression ratio, with the expectation of more compression artifacts; (2) downsampling, e.g., converting from VGA to QVGA; and/or (3) removing the bulk of a given segment, but leaving a selection of key-frames to represent the segment, e.g., individual still images.

Under a heavy usage scenario of a user capturing video images without pausing to consider the memory usage, the memory card could conceivably contain just a collection of individual frames due to heavy discarding of stored data as set forth above. However, under a normal operating video capture, the lower quality still frames would be erased to sensibly free up space and leave higher quality video captures.

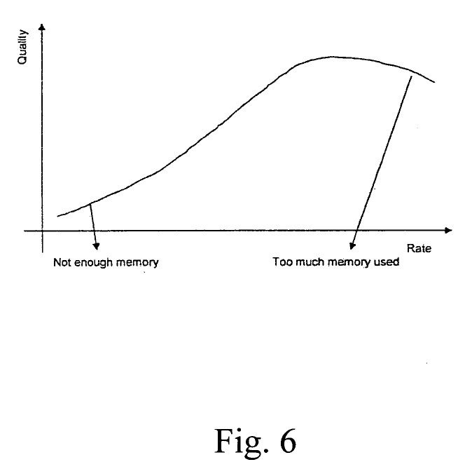

As illustrated in FIG. 6, when there is not enough memory, the video quality can be low due to excessive deletion of video materials. Likewise, when too much memory is used, the video quality can also be low due to redundancy or low quality segments in the materials.

To a certain extent, the approach is similar to the rate-distortion optimization used in image/video compression. (See, Ortega et al., “Rate-Distortion Methods for Image and Video Compression,” IEEE Signal Processing Magazine, Nov. 1998, pp 23-50.) However, as distinguished from the Lagrangian optimization, we apply a relationship that a distortion is inversely proportional to the quality,

Distortion ∝1/Qᵢ, (6)

in this way being able to use the formulation described in the reference above. Furthermore, a number of unique heuristic rules are applied to the optimization for the onboard camera video editing. For example, the onboard camera video editing can give more weight to removing short micro-shots of very bad quality and less weight to removing frames from relatively long μ-shots to reduce the occurrences of disrupted scenes.

A video quality optimizer removes at least one video segment with low quality from the digital memory to provide increased memory space for future video capture. During the optimization procedure, short μ-shots with very low quality, or segments within μ-shots which are of low quality, are removed to save space for future video capture. With each deletion of video segment or μ-shot or a newly captured video clip, the video quality ranking is updated. And the optimization procedure is repeated, as long as the user needs more space. In case of memory shortage, e.g., when the number of μ-shots is greater than an upper limit, the solution can resort to a collection of keyframes.

In determining video quality, a conservative mode and a fully automatic mode can be configured for the user. In the conservative mode, the user can have full control to decide to erase a segment or μ-shot. At each optimization procedure, the highest ranked candidates for deletion can be shown to the user for user deletion. For the fully automatic mode, low quality video up to a maximum length, e.g., 30 seconds, could be erased automatically each time. In either mode, a user interactive unit can be provided to furnish advice on how to manage the digital memory or the video quality.

The executable instructions of a computer program, as exemplified in FIGS. 3 and 4, can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or a removable storage device. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. An onboard camera video editing system having a digital memory to capture video, the system comprising:
a video segmentation unit which segments a video clip into one or more video segments having frames;
a video quality assessment unit which assesses video quality of at least one frame and derives a quality score per frame and an average quality score for the video segment; and
a video quality optimizer which removes at least one video segment with low quality from the digital memory to provide increased free memory space for future video capture.

2. The onboard camera video editing system according to claim 1, wherein the video segmentation unit segments video into semantic units.

3. The onboard camera video editing system according to claim 2, wherein segmenting video into semantic units is conducted by analyzing at least one video features chosen from the group comprising camera motion, color histogram, audio events and other low level audio and video features.

4. The onboard camera video editing system according to claim 1, wherein the video quality assessment unit evaluates video quality using high and low level features.

5. The onboard camera video editing system according to claim 1, comprising an estimation unit which estimates user's subjective pressure in relation to memory usage.

6. The onboard camera video editing system according to claim 1, comprising a user interactive unit which provides the user advice on how to manage the digital memory or the video quality.

7. The onboard camera video editing system according to claim 1, wherein the onboard camera video editing system optimizes the video quality when not in a video capture mode.

8. The onboard camera video editing system according to claim 1, wherein a conservative mode and a fully automatic mode are provided for video editing.

9. The onboard camera video editing system according to claim 1, wherein video quality of each μ-shot and frames within it are assessed by detecting and analyzing at least one video feature chosen from the group comprising camera motion, luminance histogram analysis to identify bad exposure, out-of-focus detection, brightness, noisy frame detection, shaking and rotation, periodic camera motion or large amplitude of rotation detection, audio highlights detection, face detection, and detection of other metadata at different levels.

10. A video editing method to edit captured video for a digital memory, the method comprising:
segmenting a video clip into at least one video segment having frames;
assessing the video quality of at least one frame to derive a quality score per frame and an average quality score for the video segment; and
removing at least one video segment from the digital memory based on the quality score per frame and the average quality score to optimize quality of the video captured in the digital memory and to increase free memory space.

11. The video editing method according to claim 10, wherein the segmenting of a video clip segments video into semantic units.

12. The video editing method according to claim 10, wherein the assessment of the video quality uses high and low level features.

13. The video editing method according to claim 10, comprising an estimation unit which estimates user's subjective pressure in relation to memory usage.

14. The video editing method according to claim 10, comprising providing the user advice on how to manage the digital memory or the video quality.

15. The video editing method according to claim 10, wherein the video quality is optimized when not in a video capture mode.

16. The video editing method according to claim 10, wherein a conservative mode and a fully automatic mode are provided for video editing.

17. The video editing method according to claim 10, wherein video quality of each μ-shot and frames within it are assessed by detecting and analyzing at least one video feature chosen from the group comprising camera motion, histogram analysis to identify bad exposure, out-of-focus detection, brightness, noisy frame detection, shaking and rotation, periodic camera motion or large amplitude of rotation detection, audio highlights detection, face detection, and detection of other metadata at different levels.

18. The video editing method according to claim 10, wherein the method is used to edit captured video for a digital memory, such as a random access memory, other solid-state memory, blue ray disc, and various forms of HD DVD.

19. A computer-readable medium having a program executable to edit captured video for consistency in visual quality, the program implementing a method comprising:
receiving μ-shots for storage in a digital memory;
erasing segments of a given μ-shot to achieve a level of overall quality Qₒᵥₑᵣₐₗₗ of modified μ-shots for storage in the digital memory.

20. The computer-readable medium according to claim 19, wherein, if the segments remaining in the memory possess higher quality levels than a given threshold quality value, then at least one of the following steps are taken to further free up the digital memory: recompressing a given segment to a higher compression ratio, downsampling, and removing the bulk of a given segment.

21. The computer-readable medium according to claim 19, wherein:
Qₒᵥₑᵣₐₗₗ=Σ \hat{Q}ᵢ/N;
\hat{Q}ᵢ quantifies modified μ-shot quality; and
N is the number of modified μ-shots in the digital memory.

22. The computer-readable medium according to claim 21, wherein the modified μ-shot quality \hat{Q}ᵢ is based on at least one of:
fᵢ=a function of μ-shot recompression;
fᵢ′=a function of μ-shot down sampling; and
fᵢ″=a function of frame deletions.
